(19) United States
(12) Patent Application Publication
(10) Pub. No.: US 2014/0093751 A1
(43) Pub. Date: Apr. 3, 2014

(54) HOUSING ASSEMBLY, SECONDARY BATTERY COMPRISING AT LEAST TWO SECONDARY CELLS AND SAID HOUSING ASSEMBLY, AS WELL AS A METHOD FOR MANUFACTURING THE HOUSING ASSEMBLY

(71) Applicant: Li-Tec Battery GmbH, Kamenz (DE)

(72) Inventors: Tim SCHAEFER, Harztor (DE); Werner Hufenbach, Dresden (DE); Marco Zichner, Dresden (DE)

(73) Assignee: Li-Tec Battery GmbH, Kamenz (DE)

(21) Appl. No.: 13/943,436

(22) Filed: Jul. 16, 2013

Related U.S. Application Data
(60) Provisional application No. 61/671,835, filed on Jul. 16, 2012.

(30) Foreign Application Priority Data
Jul. 16, 2012 (DE) 10 2012 013 977.2

(51) Int. Cl. H01M 10/42; H01M 10/48; H01M 10/44; H01M 2/02

(52) U.S. Cl. CPC H01M 10/4257; H01M 2/0217; H01M 10/482; H01M 10/441
USPC 429/7; 429/163; 29/623.1; 429/90

(57) ABSTRACT

A housing assembly (5) for a secondary battery (1), comprising

a receiving space (11) designed to receive at least one secondary cell (2, 2a),

a wall (4) designed to delimit, in particular protect, the receiving space (11),

particularly with respect to the environment,

wherein the wall (4) comprises at least:

one functional device (8, 8a, 8b), which is designed to enable and/or assist the release of energy from the at least one secondary cell (2, 2a), particularly to a load (12), which is designed for the particularly electrical operative connection to the at least one secondary cell (2, 2a), and

one first support element (7) which is designed to support the at least one functional device (8, 8a, 8b), wherein the first support element (7) is formed particularly at least sectionally from a fiber-interspersed first polymer material.

The present invention relates to a housing assembly, a battery case comprising said housing assembly, a secondary battery comprising at least two secondary cells and said housing assembly as well as a method for manufacturing the housing assembly. The invention will be described in conjunction with lithium-ion batteries to supply motor vehicle drives. It is noted that the invention can also be used independent of the converter cell chemistry or the design of the battery or independent of the type of drive supplied.

Secondary batteries having a battery case and a plurality of secondary cells are known in the prior art for supplying motor vehicle drives. The battery case serves in particular to accommodate the secondary cells. The battery case is usually of multi-element configuration.

The high expenditure involved in manufacturing various types of secondary batteries is at times seen to be problematic.

It is an object of the invention to provide a secondary battery which can be manufactured at lower expenditure or costs respectively.

This object is achieved by a housing assembly in accordance with claim 1. Claim 4 describes a battery case. Claim 5 describes a secondary battery comprising the housing assembly and two secondary cells. The objective is also achieved by a manufacturing method for the housing assembly in accordance with claim 7. Preferential further developments of the invention constitute the subject matter of the subclaims.

A housing assembly according to the invention is provided for a secondary battery; i.e. a rechargeable battery. The housing assembly comprises a receiving space. The receiving space is designed to receive one or more secondary cells. The housing assembly has one or more walls. The at least one wall is designed to delimit, in particular protect, the receiving space, particularly with respect to the environment. In particular, at least sections of the one or more walls comprise at least one or more functional devices. Said at least one functional device is designed to enable and/or assist the release of energy from the at least one secondary cell, particularly to an independent load. The at least one functional device is designed for the particularly electrical operative connection to at least one of the secondary cells. The functional device is designed to exchange electrical energy with at least one of the secondary cells. The wall comprises at least one first support element. The first support element is designed to support the at least one functional device. The first support element is formed from a fiber-interspersed first polymer material, particularly at least in sections.

The first support element serves particularly in supporting the at least one functional device; i.e. in particular counteracting unwanted relative displacement of the at least one functional device relative the converter cell. The first support element serves particularly in protecting the at least one functional device from harmful environmental effects.

The secondary battery comprises one or more secondary cells designed to intermittently release and intermittently absorb electrical energy.

With the inventive design of the housing assembly, the functional device takes on a plurality of functions related to the operation of the secondary battery, or the at least one secondary cell respectively, which are performed by separate components in the known designs of secondary batteries. A plurality of discrete components or functional elements are centralized in the at least one functional device, in particular as its own functional module. Hence, less components are required to manufacture the inventive housing assembly, secondary battery respectively, thereby reducing the manufacturing and/or assembling expenditure. The underlying objective is thus achieved.

The inventive housing assembly further provides the advantage of increased service life due to the first support element protecting the underlying functional device from mechanical damage, particularly from a foreign object impacting the wall. The inventive housing assembly further provides the advantage of increased service life due to the first support element improving the cohesion of the functional device, particularly in the case of accelerations or vibrations during the operation of the secondary battery, particularly for supplying a motor vehicle.

### TERMINOLOGY

In the terms of the invention, a secondary battery is to be understood as an apparatus which is in particular designed to at least intermittently release or provide electrical energy as well as absorb electrical energy. The secondary battery has a battery charging capacity C_{b} [Ah]. A differentiation is made in the present case between a used secondary battery, the secondary cells of which have aged in comparison to new secondary cells of the same type, and a secondary battery still to be manufactured.

In the terms of the invention, a secondary cell is to be understood as a device which is in particular designed to at least intermittently release electrical energy, absorb electrical energy, as well as reversibly convert electrical energy into chemical energy. The secondary cell is able to supply a cell voltage. The secondary cell has a cell charging capacity Cₐ [Ah]. The secondary cell exhibits a state of charge which is preferably indicated as a percentage [%] of the cell charging capacity.

The secondary cell preferably comprises two cell terminals of different polarity for the at least intermittent cell voltage contact. The secondary cell preferably comprises a separator between two electrodes of different polarity as well as an electrolyte for the electrical operative connection of the electrodes. The secondary cell preferably comprises a plurality of arrangements of two electrodes of different polarity each distanced from each other by a separator. The electrodes and separators are preferably enclosed in a casing, wherein the casing is designed so as to counter an exchange of material with the environment. It is particularly preferential for the secondary cell to comprise lithium or lithium ions. A differentiation is made in the present case between a used secondary cell and a new secondary cell, wherein the cell charging capacity of the used secondary cell is less than the cell charging capacity of a new secondary cell of the same type.

In accordance with a first preferential embodiment, the secondary cell comprises an electrode stack and has a substantially cuboid shape. In accordance with a second preferential embodiment, the secondary cell comprises a flat-wound electrode and has a substantially cuboid shape. In accordance with a third preferential embodiment, the secondary cell comprises an electrode coil and has a substantially cylindrical shape.

In the terms of the invention, a housing assembly is to be understood as a device which is in particular designed to accommodate one or more of said secondary cells. To this end, the housing assembly has a receiving space designed to receive one or more of said, particularly used, secondary cells. The receiving space is preferably adapted to substantially cuboid or substantially cylindrical secondary cells. The housing assembly further comprises a wall. The housing assembly is preferably designed to enclose at least sections of the secondary cells of the secondary battery, in particular substantially completely. The housing assembly, its receiving space respectively, is preferably of substantially cuboid configuration. Said housing assembly can preferably be connected to a second housing part of the same secondary battery, whereupon the housing assembly and the second housing part form the battery case.

In the terms of the invention, a wall is to be understood as a device which is in particular designed to:
delimit the receiving space, particularly relative the environment, and/or
define the boundary of the receiving space, particularly relative the environment, and/or
protect the secondary cells accommodated within the receiving space, particularly from a foreign object from the environment of the secondary cell, and/or
hinder the exchange of material between the environment and the receiving space, and/or
at least intermittently perform a function for the supplying of electrical energy by the at least one secondary cell,
support at least one of the secondary cells in countering contact and/or an unwanted relative motion vis-à-vis the wall or a neighboring secondary cell.

To this end, the wall comprises at least one functional device and at least one first support element, particularly at least sectionally. The at least one functional device is preferably at least sectionally connected, particularly materially, to the at least one first support element. The wall preferably also comprises a second support element, whereby the second support element substantially corresponds to the first support element, wherein the at least one functional device is arranged between the first support element and the second support element.

In the terms of the invention, a functional device is to be understood as a device which is in particular designed:
to enable and/or support the release of energy from the at least one secondary cell, particularly to a load, and/or
for the separable, particularly electrical, connection, operative connection in particular, to the at least one secondary cell, particularly to a plurality of said secondary cells, and/or
for the at least indirect electrical connection to a load to be supplied, to an independent charging device, to an independent diagnostic device, to an independent control device and/or to an independent communication device,
for the control or monitoring of the operation of the secondary battery or one of the secondary cells, particularly charging or discharging of one of the secondary cells,
to detect at least one physical parameter associated with at least one of the secondary cells,
to communicate with an independent control device or an independent communication device.

In the terms of the invention, a support element is to be understood as a device which is in particular designed to support the at least one functional device and which is in particular designed to:
protect the at least one functional device, particularly against a foreign object from the environment, and/or
hold the at least one functional device so as to be substantially immovable, particularly relative the receiving space, and/or
delimit the at least one functional device relative the environment of the secondary battery, and/or
electrically insulate the at least one functional device, particularly relative the environment of the secondary battery.

The first support element serves in particular to counteract an unwanted relative displacement of the at least one functional device relative the first support element or one of the secondary cells respectively. The first support element serves in particular to protect the at least one functional device particularly from harmful effects from the environment of the secondary battery. To this end, the first support element is faced toward the environment of the secondary battery. The first support element is formed from a polymer material. The first support element is preferably formed as a first base layer. This design provides the advantage of the first support element being able to support the at least one functional device along a greater area, wherein particularly the integrity of the at least one functional device is improved.

In the terms of the invention, a physical parameter refers to a specific characteristic or characteristic property, particularly of one of the secondary cells, which in particular:
enables inferring a desired state of one of the secondary cells, and/or
enables inferring an unplanned and/or unwanted state of one of the secondary cells, and/or
can be detected by a sensor, wherein the sensor can at least intermittently provide a signal, preferably an electrical voltage or an electric current, and/or
can be processed by a control device, particularly the battery control device, can be in particular linked to a target value, can be in particular linked to another of the detected physical parameters, and/or
provides information as to the cell voltage, cell current, cell temperature, the pressure in one of the secondary cells, the pressure in the receiving space, the integrity of one of the secondary cells, the release of substance from one of the secondary cells, the presence of a foreign substance particularly from the environment of one of the secondary cells and/or the state of charge of one of the secondary cells, and/or
can suggest a transformation of one of the secondary cells into another state.

In the terms of the invention, the terminal voltage or open-circuit voltage of the secondary cell is also considered cell voltage. In the terms of the invention, the electric current into the secondary cell or the electric current out of the secondary cell is also considered cell current.

In the terms of the invention, the operational data is particularly to be understood as information collected or gained during the operation of a secondary battery or one of the secondary cells of the secondary battery. This also includes:
detected physical parameters as well as associated measured values related to the secondary battery or one of the secondary cells,
progress messages, generated for example by a control device which controls and/or monitors the operation of the secondary battery or one of the secondary cells, particularly generated by said battery control device,
error messages which provide information on faulty or insufficient function particularly of the secondary battery or one of the secondary cells,
commands and/or signals sent or received by the control device, particularly the battery control device.

### PREFERENTIAL EMBODIMENTS

The first support element is preferably at least sectionally connected, particularly materially, to the at least one functional device. This preferential embodiment provides the advantage of countering an unwanted relative motion of the first support element and the at least one functional device.

The first support element is preferably configured as a first base layer. This embodiment provides the advantage of the first support element being able to support the at least one functional device along a greater area, whereby particularly the integrity of the at least one functional device is improved.

The first support element preferably comprises glass fibers, carbon fibers, basalt fibers and/or aramid fibers, wherein the fiber material particularly serves in reinforcing the first support element. It is particularly preferential for the fiber material to in particular be of non-woven or woven textile design and be substantially fully encased by the first polymer material. This preferential embodiment provides the advantage of increasing the first support element's inherent stability and/or rigidity.

In accordance with one first preferential embodiment, said polymer material is formed from thermoplastic. The wall can thus be reshaped when heated. The polymer material's softening temperature, in particular 10 K, is preferably higher than the operating temperature range of the secondary battery. The present preferential embodiment provides the advantage of simplifying the manufacture of the housing assembly. The present preferential embodiment provides the advantage of improving the inherent stability of the wall within the operating temperature range.

In accordance with a second preferential embodiment, said polymer material can be hardened. Said polymer material is preferably taken from the following group comprising epoxy resins and polyester resins. The present preferential embodiment provides the advantage of improving the inherent stability of the wall, particularly at temperatures higher than 130° C.

The at least one functional device preferably comprises at least one or more functional elements, wherein the at least one functional element can be connected, particularly electrically, to one or more of the secondary cells. Said functional element enables the at least one functional device to at least intermittently perform a function for the supply of electrical energy by the secondary battery or by at least one of the secondary cells.

At least one or more of said functional elements is preferably designed as:
a battery terminal for connecting to a load to be supplied, or
a sensor for detecting one of said physical parameters, particularly for detecting the cell voltage or the cell current relative at least one of said secondary cells, wherein the sensor can at least intermittently provide a measured value which is proportional to the detected physical parameter, particularly to the battery control device, or
a battery control device for controlling or monitoring the operation and/or function of the secondary battery, particularly for controlling or monitoring charging or discharging of one of the secondary cells, wherein the battery control device is preferably designed as a microprocessor or an application-specific integrated circuit, or
an interconnect device designed for the connecting and/or the separable electrical connection of the at least one secondary cell to at least one of the battery terminals, particularly to a load to be supplied, which can be controlled particularly by the battery control device, comprising in particular contact elements for one or more of said secondary cells, or
a switch element which can be controlled particularly by the battery control device and is designed in particular for the reversible bypassing of one of said secondary cells, which is in particular part of the interconnect device which can particularly be controlled by the battery control device, or
a fluid passage which can be controlled particularly by the battery control device and is in particular designed to enable inflow of a temperature-control fluid or an extinguishing agent to at least one of said secondary cells, or
an actuating device which is designed to activate an independent device, in particular a fluid conveyor device for the conveying of the temperature-control fluid or extinguishing agent, which can in particular be controlled by the battery control device, or
a communication device which can in particular be controlled by the battery control device and which is designed to communicate signals, detected physical parameters, measured values, target values, progress messages, error messages or commands, particularly to an independent control device, or diagnostic device which is preferably designed as a beeper, light-emitting diode, infrared interface, GPS device, GSM assembly, first short-range wireless device or transponder, or
a data storage device designed to store detected physical parameters, measured values, target values, progress messages, error messages and/or operating instructions, which is preferably designed for exchanging data with the battery control device and/or the communication device and which can in particular be controlled by the battery control device.

The at least one sensor is designed to detect one of said physical parameters of at least one of the secondary cells and provide same to the battery control device, particularly as a measured value. The sensor is preferably designed as a: voltage detector, current detector, temperature sensor and/or thermoelectric element, pressure sensor, chemical substance sensor, hereinafter referred to as a “material sensor,” gas sensor, liquid sensor, position sensor or acceleration sensor, wherein the sensors particularly serve in the detecting of at least one physical parameter of one of said secondary cells, particularly the electrode assembly. The sensor is preferably designed to detect the cell voltage, i.e. the electrical voltage and/or terminal voltage of the secondary cell, to detect the cell current, i.e. the intensity of the electrical current supplied to or withdrawn from the secondary cell, or to detect the cell temperature; i.e. the temperature of an exterior surface of said secondary cell.

The interconnect device preferably comprises a plurality of switch elements, designed in particular as semiconductor switches, which are designed and disposed for the series and/or parallel connection of a plurality of said secondary cells. One or more of said contact elements are preferably designed as spring-loaded plug contacts for contacting a respective one of said secondary cells.

In accordance with a first preferential further development of the series connection of at least two of said secondary cells, the interconnect device comprises one or more interconnection arrangements. Said at least one interconnection arrangement comprises three of said contact elements and one of said switch elements. The switch element is designed to at least intermittently interconnect a first of said contact elements to a second or to a third of said contact elements. The interconnect device is further electrically connected to two of said battery terminals of different polarity. The switch elements can be controlled by the battery control device. The present preferential further development provides the advantage of being able to bypass one of said secondary cells in a series connection of at least two said secondary cells.

In accordance with a second preferential further development of connecting at least two of said secondary cells in parallel, the interconnect device comprises two electrical conductors of different polarity, particularly designed as busbars. Said electrical conductors are electrically connected to two of said battery terminals of different polarity. Each of said switch elements is switched between one of said contact elements and one of said electrical conductors. One of said secondary cells is electrically connected to said contact element. Said switch element can be controlled by the battery control device. By opening the switch element, the contact element is separated from the electrical conductor and the associated secondary cell isolated. The present preferential further development provides the advantage of being able to isolate said secondary cell when insufficient function or dysfunction of the secondary cell can be assumed, particularly based on one of said detected physical parameters.

The communication device is preferably designed to transmit predefined data intermittently, in particular periodically, particularly information on a state of one of said secondary cells, particularly to an independent short-range wireless device, particularly upon request from an independent control device. It is particularly preferential for the first short-range wireless device to be designed to transmit a characteristic value for at least one of said secondary cells simultaneously with the predefined data. The present preferential design provides the advantage of the user of the secondary battery being able to gain information about the state of the secondary battery or one of the secondary cells, essentially without any action on his own part.

The functional device preferably comprises a circuit support, particularly designed as a circuit board or Kapton film. Said circuit support serves in particular to support, hold and/or electrically contact at least one or more of said functional elements. Said circuit support is designed to enable a plurality of said functional elements to interact for the faultless provision of electrical energy. Said circuit support is preferably designed to electrically connect at least two or more of said functional elements, particularly by means of one or a plurality of circuit paths. Said circuit support is preferably designed to connect, particularly materially, to the first support element. The present preferential design provides the advantage of the functional device being able to be equipped independently of the point in time of the housing assembly manufacture. This preferential design enables a simplified, particularly material connection to the first support element.

One preferential embodiment of said functional device comprises:
two of said battery terminals of different polarities (P+, P−) to which the cell voltages of the secondary cells can contact, which extend through the first support element,
the interconnect device designed to separably electrically connect the secondary cells to the battery terminals, which is connected to the battery terminals, comprising contact elements for said secondary cells,
the battery control device, which is designed to control or monitor the secondary battery and/or at least one of said secondary cells, designed to actuate the interconnect device,
preferably the data storage device designed to store data, designed to exchange data with the battery control device, which is signal-connected to the battery control device,
preferably at least one of said sensors which is particularly designed to detect the cell voltage, cell current or cell temperature,
preferably at least one of said switch elements, which is designed to reversibly bypass one of said secondary cells, which is in particular part of the interconnect device,
preferably at least one of said fluid passages designed to allow inflow of a temperature-control fluid or extinguishing agent to one of said secondary cells,
preferably at least one of said actuating devices, in particular for activating a particularly independent fluid conveyor device for a temperature-control fluid or extinguishing agent.

The present preferential embodiment provides the advantage of a used secondary cell designed without its own sensors or control device also being able to be used as part of the inventive secondary battery.

The housing assembly preferably comprises a fluid channel for guiding the temperature-control fluid. The fluid channel is connected to the at least one functional device, particularly by at least one of said fluid passages. Said fluid passage is preferably connected to one particularly independent fluid conveyor device. Said fluid passage can preferably be opened and closed, particularly by the battery control device. The fluid channel preferably at least sectionally contacts at least one lateral surface of at least one or more of said secondary cells. Thermal energy can thus be at least intermittently discharged from at least one of said secondary cells. The present preferred embodiment provides the advantage of increasing the safety of the secondary battery.

The housing assembly preferably comprises a fluid channel for guiding the extinguishing agent. The fluid channel is connected to the at least one functional device, particularly by at least one of said fluid passages. Said fluid passage is preferably connected to one particularly independent fluid conveyor device. The fluid passage can preferably be open and closed, particularly by the battery control device. Said fluid channel preferably opens into the receiving space. Hence, the receiving space, or one of the secondary cells respectively, can supply the extinguishing agent when needed, particularly in the event of a fire in one of said secondary cells. The present preferred embodiment provides the advantage of increasing the safety of the secondary battery.

The wall, preferably of the at least one functional device, particularly at least sectionally comprises an activatable filler material.

At least one or more of said functional devices is/are preferably:
designed so as to be at least sectionally porous, particularly preferably with a foam, whereby a predefined outer geometry can in particular be attained for the secondary battery, whereby particularly the flexural rigidity of the housing assembly or its wall is increased, whereby a volume is particularly sectionally formed for the decelerating or receiving respectively of a foreign object impacting the secondary battery, whereby in particular a section of the housing assembly is formed with reduced thermal conductivity, and/or
designed with a hollow structure, particularly with a honeycomb structure, whereby particularly the flexural rigidity of the housing assembly is increased, whereby a volume is particularly sectionally formed for the decelerating or receiving respectively of a foreign object impacting the secondary battery, whereby in particular a section of the housing assembly is formed with reduced thermal conductivity, and/or
designed with at least one cavity particularly for a temperature-control fluid, whereby the temperature-control fluid serves in the exchange of thermal energy with at least one of the secondary cells, whereby the temperature-control fluid flows through the cavity particularly when the temperature of one of the secondary cells exceeds or falls below a limit temperature, and/or
designed at least sectionally with an expanding filler material which is provided to form cavities, particularly upon the introduction of activation energy, particularly form cavities triggered by one of said functional elements, and/or
designed at least sectionally with a filler material having phase change ability particularly within the secondary cell's predefined operating temperature range, whereby the filler material can intermittently exchange thermal energy particularly with at least one of the secondary cells so as to warm or cool same, and/or
designed at least sectionally with a chemically reactive filler material which is preferably provided to chemically bind a substance, particularly from at least one of the secondary cells, preferably after the release of the substance from one of the secondary cells, and/or
designed with a first layer section having a first wall thickness and a second layer section having a second wall thickness, wherein the break line from the second wall thickness to the first wall thickness exhibits a predefined value of less than 1, preferably less than 0.9, preferentially less than 0.8, preferentially less than 0.7, preferentially less than 0.6, preferentially less than 0.5, preferentially greater than 0.05, wherein the first layer section preferably exhibits a lower density than the second layer section.

The functional device is preferably designed to be partially porous with embedded microspheres in accordance with the teachings of U.S. Pat. No. 3,615,972 or U.S. Pat. No. 4,483,889. The present preferential embodiment provides the advantage of simplifying the manufacture of the housing assembly. The porosity of the functional device can counter increased thermal resistance to a flow of heat through the wall. The porosity of the functional device can at least partially convert the energy as effected as applicable by a foreign object impacting the housing assembly into deformation energy. The present preferential embodiment provides the advantage of increasing the secondary battery's operational safety.

The functional device is preferably designed as a flame retardant or fire protection. To this end, the functional device comprises chemically reactive, flame-retarding material and is preferably configured as a layer or deposit. This design provides the advantage of improving the operational safety of the secondary battery in the event of a fire in its proximity.

The chemically reactive filler material preferably acts as a flame retardant, in particular by forming a protective layer or by halting a chain reaction with radicals. The filler material is preferably selected from the following group which comprises: alum, borax, aluminum hydroxide, substances with M^{I}M^{III}(SO₄)₂ and with water of crystallization, wherein M stands for a metal ion of the I/Ill oxidation state, particularly preferably potassium aluminum sulfate. The present preferential embodiment provides the advantage of being able to win time for said functional device to take further measures to reduce the danger which can result from an overheated secondary battery, or secondary cell respectively, in the event of a fire in the proximity of the secondary battery.

In accordance with a first preferred further development, the functional device is designed as an insert impregnated with the filler material, particularly preferentially as a cotton layer. The present preferential further development provides the advantage of increasing the operational safety of the secondary battery.

In accordance with a second preferred further development, the functional device is pressed from a powder of the filler material. The present preferential further development provides the advantage of improving the protection of the secondary cells in the event of a fire in the proximity of the secondary battery. The present preferential further development provides the advantage of increasing the operational safety of the secondary battery.

Should the secondary battery and/or the housing assembly be damaged, a substance from the secondary battery's environment can enter into the receiving space and react with a substance of one of the secondary cells to form a hazardous substance. The chemically reactive filler material is preferably provided to chemically bind said hazardous substance. Said filler material preferably comprises a saline substance, particularly preferably a substance of the following group comprising: halides, sulfates, phosphates, salts of organic acids, salts of carbonic acids, salts from alcohols, hydroxides. Particularly when water and/or water vapor infiltrates the cell housing and the electrolyte contains fluorine or fluorine ions, hydrogen fluoride (HF) can form. The filler material particularly preferentially comprises calcium chloride and/or calcium hydroxide, particularly for binding hydrogen fluoride. The present preferred embodiment provides the advantage of countering the risk associated with a hazardous substance leaking out of one of the secondary cells.

The expandable filler material is preferably formed by an organic aerogel having a three-dimensional scaffold of primary particles. Said primary particles grow to one another in wholly random order particularly by pyrolysis or intense thermal radiation, wherein cavities form between the particles. Said cavities reduce the thermal permeability of the wall. The present preferred embodiment provides the advantage of improving the housing assembly's flame resistance. The present preferred embodiment provides the advantage of reducing functional device and/or housing assembly heat transmission, particularly in the event of a fire in the proximity of the secondary battery or damage to one of the secondary cells. The present preferred embodiment provides the advantage of reducing functional device and/or housing assembly heat transmission, particularly in the event of unwanted high temperature of one of the secondary cells, and counteracting damage to an adjacent secondary cell. The present preferential embodiment provides the advantage of being able to win time for said functional device to take further measures to reduce the danger which can result from an overheated secondary cell in the event of a fire in the proximity of the secondary battery.

The expandable filler material is preferably formed by expanded mica and/or vermiculite. Water of crystallization is chemically bound between the layers of its flake-like structure. Upon thermal action, the chemically bound water is abruptly expelled, whereby the vermiculite is inflated to many times its volume. The present preferential embodiment provides the advantage of reducing functional device and/or housing assembly heat transmission, particularly in the event of a fire in the proximity of the secondary battery or damage to one of the secondary cells. The present preferential embodiment provides the advantage of reducing functional device and/or housing assembly heat transmission, particularly in the event of unwanted high temperature of one of the secondary cells, and counteracting damage to an adjacent secondary cell. The present preferential embodiment provides the advantage of being able to win time for said functional device to take further measures to reduce the danger which can result from an overheated secondary cell in the event of a fire in the proximity of the secondary battery.

The functional device is preferably designed as a mat or a plate which extends along at least one area of one of the secondary cells, particularly along a lateral surface of one of said secondary cells.

The functional device is preferably designed as a mat or a plate which largely covers one of the lateral surfaces of the secondary cells. The functional device comprises an expandable filler material which is designed to increase its specific volume, i.e. its volume per unit mass, above a threshold temperature, particularly by forming cavities. The filler material is preferably designed to form a foam. The thermal conductivity of the functional device is reduced by the filler material increasing its specific volume. With increased specific volume, the flow of heat through the housing assembly as well as the exchange of thermal energy with one of the secondary cells per time unit is reduced. The functional device preferably comprises a silicate, further preferentially a sodium silicate, particularly preferentially Palstop®. The present preferential embodiment provides the advantage of improving the protection of the secondary cell against thermal effect from the environment of the secondary cell, particularly in the event of a fire in its proximity. The present preferential embodiment provides the advantage of being able to win time for said functional device to take further measures to reduce the danger which can result from an overheated secondary cell in the event of a fire in the proximity of the secondary battery. The present preferential embodiment provides the advantage of counteracting the introduction of thermal energy in a secondary cell.

The expandable filler material is preferably configured such that the specific volume of the filler material is increased endothermically. With continuous inflow of thermal energy into the secondary battery, a portion of said thermal energy is consumed in increasing the specific volume of the filler material. The present preferential embodiment provides the advantage of being able to win time for said functional device to take further measures to reduce the danger which can result from an overheated secondary cell in the event of a fire in the proximity of the secondary battery.

The functional device is preferably designed as a mat or a plate which largely covers one of the lateral surfaces of the secondary cells. The functional device at least intermittently comprises a filler material having phase change ability, preferably water, particularly before the specific volume of one of the functional device's said expandable filler materials is increased. The functional device is preferably designed with at least one microsphere which contains said filler material in accordance with the teachings of U.S. Pat. No. 6,703,127 or U.S. Pat. No. 6,835,334. With a continued inflow of thermal energy into the secondary battery, a portion of said thermal energy is consumed in the transitioning of the originally particularly liquid filler material into its gaseous phase. Thus, in consequence, the temperature of one of the secondary cells further increases above the evaporating temperature of the filler material while its phase transition is delayed. The present preferential embodiment provides the advantage of being able to win time for said functional device to take further measures to reduce the danger which can result from an overheated secondary cell in the event of a fire in the proximity of the secondary battery. This preferred embodiment can advantageously be combined with the third preferential embodiment.

The functional device is preferably designed as a mat or a plate which largely covers one of the lateral surfaces of the secondary cells. The functional device comprises an expandable filler material which is designed to increase its specific volume, i.e. its volume per unit mass, particularly by forming cavities, particularly at a predefined housing assembly temperature or at a predefined temperature in the vicinity of the secondary battery. The filler material is preferably designed to form a foam. The expandable filler material is preferably designed with at least one microsphere in accordance with the teachings of U.S. Pat. No. 3,615,972 or U.S. Pat. No. 4,483,889. During the operation of the secondary battery, its housing assembly can be damaged, particularly by a foreign object. Said damage to the first support element can lead to an exchange of material between the environment and the receiving space. As the specific volume of the filler material increases, this damage can be lessened and/or sealed off. This preferential embodiment provides the advantage of improving the passive safety of the secondary battery. The expandable filler material preferably comprises a polymer material having at least one functional group, particularly preferentially having an OH group, an NH₂ group or a radical such as Cl. The polymer material is preferably suited for chemical reaction with a material from the environment of the secondary battery or an additive of the electrolyte. The polymer material expands during said chemical reaction. The chemical reaction preferably takes place as polymerization, particularly under cross-linking of adjacent polymers. It is particularly preferential for an elastomer to be embodied at least in sections during the cross-linking.

During the operation of the secondary battery, its housing assembly can be damaged, particularly by a foreign object. Said damage can lead to an exchange of material between the environment and the receiving space. The polymer material can come into contact with a material from the environment of the secondary battery or an additive of the electrolyte of one of the secondary cells particularly when the first support element adjacent the functional device is damaged. As the specific volume of the filler material increases, said damage to the first support element can be lessened and/or sealed off. This preferential embodiment provides the advantage of improving the passive safety of the secondary battery.

During the operation of the converter cell, its cell casing can become untight as a result of increased internal pressure. As the specific volume of the filler material designed as said polymer material having at least one functional group increases, said damage to the first support element can be lessened and/or sealed off. This preferential embodiment provides the advantage of improving the passive safety of the secondary battery.

The expandable filler material preferably comprises a polymer material, particularly preferentially an elastomer which is suited to accommodating a solvent from the electrolyte. The elastomer material could come into contact with said solvent particularly in the area of damage to the support element adjacent the functional device. As the polymer material at least sectionally accommodates the solvent, the specific volume of the functional device increases at least sectionally. As the specific volume of the filler material increases, said damage to the first support element can be lessened and/or sealed off. This preferential embodiment provides the advantage of improving the passive safety of the secondary battery.

The functional device preferably comprises a gelling agent, particularly Firesorb®. Said gelling agent serves in particular to form a protective layer on the wall and hold same there. The protective layer serves in particular to limit thermal flow through the functional device. Said gelling agent serves in particular to form a gel with water of particularly the same functional device. The gel is to cover at least sections of the housing assembly and in particular reduce thermal flow through the functional device. This preferential embodiment provides the advantage of improved protection of the secondary battery against the effect of heat from the environment, particularly upon a fire in the environment. The present preferential embodiment provides the advantage of being able to win time for said functional device to take further measures to reduce the danger which can result from an overheated secondary cell in the event of a fire in the proximity of the secondary battery. This preferential embodiment provides the advantage of being able to reduce receiving space thermal flow. This preferential embodiment provides the advantage of improving the passive safety of the secondary battery.

The functional device preferably comprises a filler material which releases an inert gas, particularly N₂ or CO₂, particularly at increased temperature. The inert gas is preferably received by at least one storage body in the functional device. Said storage bodies are provided to release the inert gas upon predefined conditions, particularly above a minimum temperature. The release of the inert gas inhibits a chemical reaction in the proximity of the functional device, particularly a fire. It is particularly preferential for said storage bodies to be formed as microspheres in accordance with one of the teachings of U.S. Pat. No. 6,703,127 or U.S. Pat. No. 6,835,334. The present preferential embodiment provides the advantage of being able to win time for said functional device to take further measures to reduce the danger which can result from an overheated secondary cell in the event of a fire in the proximity of the secondary battery. This preferential embodiment provides the advantage of improving the passive safety of the secondary battery.

The functional device preferably comprises a chemically reactive filler material. Said chemically reactive filler material is selected such that it will react upon damage or particularly unwanted opening of the housing assembly respectively. When the housing assembly is damaged, this chemical reaction within the functional device can contribute to lessening and/or sealing off said damage and/or opening. The filler material is preferably selected from the following group comprising: polyurethanes, cyanoacrylates, silicones. Said filler material is preferably suited to reacting or hardening with water from the environment or with moisture. The functional device is preferably designed as a mat or a plate which extends along at least one area of one of the secondary cells. This preferential embodiment provides the advantage of improving the passive safety of the secondary battery.

The functional device preferably comprises a chemically reactive filler material. Said chemically reactive filler material is selected such that it will react upon damage or particularly unwanted opening of the housing assembly respectively. When the housing assembly is damaged, this chemical reaction within the functional device can contribute to lessening and/or sealing off said damage and/or opening. The filler material is preferably selected from the following group comprising: unsaturated polyester resins, epoxy resins, polymers with an isocyanate group, polyurethanes, polymers with a double bond between carbon atoms, acrylates, methacrylates. The reactant is preferably taken from the following groups comprising: amines, acids, hydroxides, alcohols, polyols, isocyanates, peroxides.

Said reactant is preferably disposed in a second of said functional devices. The second functional device is preferably formed as a mat or plate extending sectionally along one of the secondary cells. The first functional device and the second functional device are preferably arranged adjacent one another between two of said support elements. It is particularly preferential for the first functional device and the second functional device to be spaced apart by means of a third of said functional devices. When a foreign object intrudes into the housing assembly and effects contact of the chemically reactive filler material with the reactant, the chemical reaction then serves to lessen the opening or seal the housing assembly respectively. Thus, by its intrusion into the housing assembly, the foreign object can effect a contact of the chemically reactive filler material with the associated reactant directly at the site of the damage. This preferential embodiment provides the advantage of improving the passive safety of the secondary battery.

Said reactant is preferably accommodated by at least one storage body. Said storage body is part of the same functional device. The storage body preferably has a thin-walled shell encasing said reactant. Said storage body is preferably arranged at a location on the housing assembly which has a higher probability of being damaged by a foreign object. When a foreign object intrudes into the housing assembly, damages the storage body and effects contact of the chemically reactive filler material with the reactant, the chemical reaction then serves to reduce the opening or seal the housing part respectively. Thus, by its intrusion into the housing assembly, the foreign object can effect a contact of the chemically reactive filler material with the associated reactant directly at the site of the damage. The storage body is preferably designed as a microsphere in accordance with the teachings of U.S. Pat. No. 6,703,127 or U.S. Pat. No. 9,835,334. This preferential embodiment provides the advantage of improving the passive safety of the secondary battery. Thus, by its intrusion into the housing assembly, the foreign object can effect a contact of the chemically reactive filler material with the associated reactant at the site of the damage.

The housing assembly preferably comprises a predetermined breaking point as well as one of said storage bodies according to the ninth preferred embodiment. Said storage body is arranged adjacent to said predetermined breaking point. When a foreign object intrudes into the housing assembly, damages the storage body and effects contact of the chemically reactive filler material with the reactant, the chemical reaction then serves to reduce the opening or seal the housing assembly respectively. Thus, by its intrusion into the housing assembly, the foreign object can effect a contact of the chemically reactive filler material with the associated reactant directly at the site of the damage. The storage body is preferably designed as a microsphere in accordance with one of the teachings of U.S. Pat. No. 6,703,127 or U.S. Pat. No. 9,835,334. This preferential embodiment provides the advantage of improving the passive safety of the secondary battery.

### PREFERRED EMBODIMENTS OF THE HOUSING ASSEMBLY

In accordance with a first preferred embodiment, a first section of said wall of the housing assembly comprises the first support element, one said functional device and the second support element. The first support element faces the environment, the second support element faces the receiving space. Both support elements are designed as base layers. Both support elements preferably comprise a thermoplastic, in particular fiber-filled. The first support element covers the functional device. The functional device is arranged between the support elements and at least sectionally connected, in particular materially, to the support elements.

The functional device comprises:
two of said battery terminals of different polarity (P+, P−) at least intermittently in contact with the cell voltages of the secondary cells to be received which extend through the first support element into the environment of the housing assembly or which are accessible from the environment through recesses of the first support element,
the interconnect device designed for the separable electrical connection of the secondary cells to be received to the battery terminals, which is designed for the connecting of the secondary cells to be received, which is connected to the battery terminals, which comprises contact elements for the secondary cells to be received, wherein said contact elements are accessible for the cell terminals of the secondary cells to be received through recesses in the second support element,
the battery control device which is designed to control or monitor the secondary battery and/or at least one of the secondary cells to be received, which is designed to actuate the interconnect device, which is designed to control the charging and discharging of the secondary cells to be received, which is designed to evaluate detected physical parameters,
the data storage device which is designed to store data, which is designed to exchange data with the battery control device, which is signal-connected to the battery control device,
one or more of said sensors, particularly per each secondary cell to be received, which is in particular designed to detect the cell voltage, cell current or cell temperature, each designed to provide the battery control device with at least one of said physical parameters or a proportional measured value thereto respectively, in particular periodically, particularly when requested by the battery control device,
one or more of said switch elements, particularly one switch element per secondary cell to be received, designed for the reversible bypassing of one of said secondary cells to be received, which is in particular part of the interconnect device.

The above-cited functional elements are centralized on one of said circuit supports and electrically interconnected. The circuit support is preferably designed as a circuit board or connected to a carrier plate. The functional device is designed to be supplied with energy from one or more of the secondary cells to be received. The functional device extends along the secondary cells to be received, particularly along the lateral surfaces of the secondary cells to be received from which the cell terminals extend.

At least one of said sensors is preferably between two of said contact elements for the same secondary cells to be received to detect the cell voltage. At least one of said sensors is preferably designed for the heat-conducting connection to one of the cell terminals of the secondary cells to be received, particularly for detecting the cell terminal temperature. Preferably at least one of said sensors is designed to detect one said cell current. At least one of said sensors is preferably designed to detect the battery power; i.e. the current supplied to or withdrawn from the secondary battery.

The present preferential embodiment provides the advantage of the functional device of the housing assembly being able to perform a plurality of functions related to the operation of the secondary battery or the at least one secondary cell respectively which, in the known secondary battery designs, are performed by discrete components. The present preferential embodiment provides the advantage of the housing assembly being able to be manufactured independently, with respect to both time and location, of the assembly of the secondary battery. The present preferential embodiment provides the advantage of improving the cohesion of the functional elements in the wall of the housing assembly relative vibrations or impacts during the operation of the secondary battery.

In a second preferred embodiment, the housing assembly comprises, in addition to the features of the first preferred embodiment, a second section of said wall with the first support element, three of said functional devices and the second support element. The first support element faces the environment, the second support element faces the receiving space. Both support elements are designed as base layers. Both support elements preferably comprise a thermoplastic, in particular fiber-filled. The first support element covers the functional device. The functional device is arranged between the support elements and at least sectionally connected, in particular materially, to the support elements. The first of said functional devices is designed as a substantially flat electrical conductor, preferably as a metal film, and is connected to one of the two battery terminals. The third of said functional devices is designed as a substantially flat electrical conductor, preferably as a metal film, and is connected to the other of the two battery terminals. The second of said functional devices is designed as an electrical insulator, preferably as an insulating film, and arranged between the first and third functional device.

A discharge resistor is preferably connected between the first or third functional device and the respective battery terminal. It is particularly preferential for said discharge resistor to be part of the functional device of the first wall.

When a foreign object penetrates into the second section of the wall from the environment and breaches the second functional device, the first and third functional device then come into electrical contact marked by contact resistance. A current path is closed upon this contact being made, whereupon the secondary cells to be received can be at least partly discharged, particularly via the contact resistance, preferably via the discharge resistor.

The present preferential embodiment provides the advantage of the functional device of the housing assembly being able to perform a plurality of functions related to the operation of the secondary battery or the at least one secondary cell respectively which, in the known secondary battery designs, are performed by discrete components. The present preferential embodiment provides the advantage of the housing assembly being able to be manufactured independently, with respect to both time and location, of the assembly of the secondary battery. The present preferential embodiment provides the advantage of improving the cohesion of the functional elements in the wall of the housing assembly relative vibrations or impacts during the operation of the secondary battery. The present preferential embodiment provides the advantage of improving the safety of a secondary battery equipped with the present embodiment of the housing assembly, particularly after an accident.

A battery case preferably comprises one of the inventive housing assemblies and a second housing part. The housing assembly can be detachably connected, particularly force-fit or materially, to the second housing part. The housing assembly comprises a closeable opening. One of more of said secondary cells can be inserted into the receiving space through said opening. The opening can be closed by the second housing part. Together, the housing assembly and second housing part, which closes the opening of the housing assembly, form the battery case. The present preferred embodiment provides the advantage of the second housing part being able to manufactured independently of the housing assembly.

The second housing part is preferably formed from a particularly at least sectionally fiber-interspersed polymer material. The polymer material of the second housing part preferably corresponds to the first polymer material. The present preferred embodiment provides the advantage of simplifying the procuring of material for manufacturing the second housing part.

The polymer material of the second housing part preferably corresponds to the first polymer material. The second housing part is preferably designed as a cover, wherein the shape of the cover substantially corresponds to the housing assembly opening. The second housing part preferably comprises a collar designed to connect to the housing assembly. The present preferred embodiment provides the advantage of simplifying the connection of the second housing part to the housing assembly.

The housing assembly and the second housing part are preferably connected together via a hinge section. The hinge section extends along a respective edge of the housing assembly and second housing part. The hinge section preferably has a thinner wall thickness than the corresponding area of the housing assembly or second housing part respectively. The present preferred embodiment provides the advantage of reducing the length of the edges to be sealed of the in particular cuboid battery case.

The housing assembly and/or second housing part preferably comprise a predetermined breaking point which is particularly preferably designed as a thin area. Said predetermined breaking point particularly serves in breaking and/or failing when the pressure inside the battery case exceeds a predetermined minimum pressure. By the predetermined breaking point failing, a substance, particularly a fluid, can escape from the battery case into the environment of the converter cell. The predetermined breaking point is preferably designed such that the open or breached predetermined breaking point forms an opening having a cross-sectional area of less than 10 mm², particularly preferentially less than 5 mm². This preferred embodiment provides the advantage of countering an uncontrolled opening of the battery case in the event of excessive internal pressure.

The predetermined breaking point is preferably designed so as to comprise a guidance device for the escaping fluid after the failure, particularly preferentially fluid guide surfaces or fluid guide elements. The present preferred embodiment provides the advantage of countering undirected leaking of a substance or fluid from the battery case into the environment.

At least one storage body having a first substance is preferably arranged in the region of the predetermined breaking point, same particularly preferably being microspheres in accordance with one of the teachings of U.S. Pat. No. 6,703,127 or U.S. Pat. No. 6,835,334. The storage body preferably has a thin-walled shell encasing said first substance. The storage body is designed and adjacent to the predetermined breaking point so as to open the predetermined breaking point and release said first substance at the same time. Said first substance is designed to seal an opening of the battery case. The first substance preferably constitutes one component of a sealant for sealing a battery case opening, wherein the sealant is composed of two components.

The other of said components is preferably part of the battery case, in particular part of the housing assembly and/or the second housing part, particularly part of one of the functional devices. It is particularly preferential for the first substance to be taken from the following group comprising: amines, acids, hydroxides, alcohols, polyols, isocyanates, peroxides. This preferential embodiment provides the advantage of increasing the passive safety of the secondary battery.

Preferably, the first substance is designed to be moisture-curing. After its release, the first substance can harden with water, particularly from the environment, preferably the atmospheric moisture. The first substance is preferably selected from the following group comprising: polyurethanes, cyanoacrylates, silicones. The present preferred embodiment provides the advantage of being able to dispense with the arranging of the second component. The present preferential embodiment provides the advantage of increasing the passive safety of the secondary battery.

The first substance is preferably designed as an adhesive with a solvent. After release, the solvent evaporates and the adhesive hardens, whereby the opening is reduced in size or closed. The present preferential embodiment provides the advantage of being able to dispense with the arranging of the second component. The present preferential embodiment provides the advantage of increasing the passive safety of the secondary battery.

The housing assembly and/or the second housing part preferably comprises a second support element arranged between at least one of said functional devices and the secondary cells. In the terms of the invention, a second support element is to be understood as a device which is designed to reinforce the housing assembly and/or second housing part.

The second support element is preferably arranged between the at least one functional device and one of the secondary cells. Preferably, the second support element is designed as a second base layer. This embodiment provides the advantage of the second support element separating the at least one functional device from the substances of the secondary cells.

The second support element is preferably connected, particularly materially, to the at least one functional device. This embodiment provides the advantage of the second base layer additionally reinforcing or mechanically stabilizing the housing part.

The second support element is preferably configured commensurate to the first support element, particular in terms of its material. This embodiment provides the advantage of reduced manufacturing costs.

The second support element is preferably designed thinner than the first support element and particularly without fiber material. This embodiment provides the advantage of reducing the time constant when detecting the temperature of one of the secondary cells.

The second support element preferably comprises at least one recess which enables direct contact for a sensor of the functional device to one of the secondary cells for detecting a substance. This embodiment provides the advantage of being able to determine the presence of hydrogen fluoride (HF) at a lower time constant.

The second support element preferably comprises at least one recess which serves in particular the electrical connection of the functional device adjacent the second support element to one of the secondary cells. This embodiment provides the advantage of the functional device having the electrical potential of one of the electrodes of the electrode assembly. This embodiment provides the further advantage of at least one of the secondary cells being able to supply energy to the functional device.

Preferably, one edge section of the housing assembly and/or the second housing part comprises a second polymer material. Said second polymer material serves in particular the material connection of the housing assembly to the second housing part. The softening temperature of the second polymer material is preferably higher than the secondary battery's operating temperature range, particularly preferentially by at least 10 K. This embodiment provides the advantage of improving the long-term sealing of the receiving space.

The second polymer material is preferably designed as a thermoplastic, particularly with a softening temperature higher than the secondary battery's operating temperature range. This embodiment provides the advantage of simplifying the feeding of the second polymer material into a forming tool. This embodiment provides the further advantage of a close, particularly gas-tight connection of the second polymer material to the housing assembly and/or the second housing part.

The second polymer material preferably encloses an edge section of the housing assembly and/or second housing part. This embodiment provides the advantage of a close, particularly gas-tight connection of the second polymer material to the housing assembly and/or to the second housing part.

Preferably, the second polymer material corresponds to the first polymer material. This embodiment provides the advantage of a close, particularly gas-tight connection of the second polymer material to the first polymer material.

### Secondary Battery with Said Housing Assembly

Preferably, a secondary battery comprises one of said inventive housing assemblies as well as two or more of said secondary cells. The secondary cells are disposed in the receiving space. The secondary battery preferably comprises the second housing part for closing the opening of the housing assembly. The present preferential embodiment provides the advantage of the functional device taking over a plurality of functions particularly related to the operation of the secondary battery, or the at least one secondary cell respectively, which in the known designs of secondary batteries are performed by discrete components. This preferred embodiment provides the advantage of fewer component assemblies being required to manufacture the secondary battery, whereby the expenditure for manufacture and/or assembly is reduced. The present preferred embodiment provides the advantage of the housing assembly being able to be manufactured independently of the assembly of the secondary battery, particularly with respect to both time and location.

The at least one functional device of the housing assembly preferably comprises:
two of the battery terminals having different polarity, to which the particularly cumulated cell voltage of the secondary cells which are disposed in the receiving space at least intermittently contact,
the interconnect device which is designed to interconnect the at least two secondary cells, particularly in a series and/or parallel connection, which is designed to at least intermittently separably connect the at least two secondary cells electrically to the battery terminals of different polarity,
the battery control device which is designed to control and/or monitor the interconnect device, which is designed to control and/or monitor the charging and/or discharging of the at least two secondary cells,
particularly preferentially at least one of the sensors which is designed to detect at least one of the physical parameters related to one of the secondary cells, wherein the at least one physical parameter allows a conclusion to be drawn as to the functioning of the secondary cell.

The present preferential embodiment provides the advantage of the functional device being able to take on a plurality of functions particularly related to the operation of the secondary battery, or the at least one secondary cell respectively, which in the known designs of secondary batteries are performed by discrete components.

Each secondary cell preferably has a charging capacity of at least 3 ampere-hours [Ah], further preferentially of at least 5 Ah, further preferentially of at least 10 Ah, further preferentially of at least 20 Ah, further preferentially of at least 50 Ah, further preferentially of at least 100 Ah, further preferentially of at least 200 Ah, further preferentially of at the most 500 Ah. This embodiment provides the advantage of improving the operating duration of the load supplied by the secondary battery.

Preferably, a current of at least 50 A, further preferentially of at least 100 A, further preferentially of at least 200 A, further preferentially of at least 500 A, further preferentially of at the most 1000 A can be at least intermittently withdrawn from the respective secondary cells, preferably over at least one hour. This embodiment provides the advantage of improving the efficiency of the load supplied by the secondary battery.

The secondary cells can preferably at least intermittently provide a respective voltage, particularly a terminal voltage of at least 1.2 V, further preferentially of at least 1.5 V, further preferentially of at least 2 V, further preferentially of at least 2.5 V, further preferentially of at least 3 V, further preferentially of at least 3.5 V, further preferentially of at least 4 V, further preferentially of at least 4.5 V, further preferentially of at least 5 V, further preferentially of at least 5.5 V, further preferentially of at least 6 V, further preferentially of at least 6.5 V, further preferentially of at least 7 V, further preferentially of at the most 7.5 V. The electrode assembly preferably comprises lithium ions. This embodiment provides the advantage of improving the secondary battery's energy density.

Preferably, the secondary battery, its secondary cells respectively, can be operated at least intermittently, particularly over at least one hour, at an ambient temperature of between −40° C. and 100° C., further preferentially between −20° C. and 80° C., further preferentially between −10° C. and 60° C., further preferentially between 0° C. and 40° C. This embodiment provides the advantage of the most unrestricted deploying or use of the secondary battery possible to supply a load, particularly a motor vehicle or a stationary system or machine.

The secondary cells preferably have a gravimetric energy density of at least 50 Wh/kg, further preferentially of at least 100 Wh/kg, further preferentially of at least 200 Wh/kg, further preferentially of at least 500 Wh/kg. The secondary cells preferably comprise lithium ions. This embodiment provides the advantage of improving the secondary battery's energy density.

The secondary battery is preferably provided for installation into a vehicle having at least one electric motor. The converter cell is preferably provided for supplying said electric motor. It is particularly preferential for the secondary battery to be provided to at least intermittently supply an electric motor of a drive train of a hybrid or electric vehicle. This embodiment provides the advantage of improving the supply of the electric motor.

The secondary battery is preferably provided for stationary use, particularly as a buffer storage, device battery, industrial battery or starter battery. The respective charging capacity of the secondary cells for these applications preferably amounts to at least 50 Ah. This embodiment provides the advantage of improving the supplying of a stationary load, in particular a stationary mounted electric motor. In accordance with a first preferential further development, the separator of one or more of the secondary cells consists of an at least partially material-permeable substrate, wherein the separator does not conduct or only poorly conducts electrons. The substrate is preferably coated on at least one side with an inorganic material. An organic material which is preferably developed as a non-woven fabric is preferably used as the at least partially material-permeable substrate. The organic material, which preferably comprises a polymer and particularly preferentially a polyethylene terephthalate (PET), is coated with an inorganic, preferably ion-conducting material which further preferably conducts ions in a temperature range of −40° C. to 200° C. The inorganic material preferably comprises at least one compound from the group of oxides, phosphates, sulfates, titanates, silicates, aluminosilicates of at least one of the elements Zr, Al, Li, particularly preferably zirconium oxide. Zirconium oxide in particular serves the separator's material integrity, nanoporosity and flexibility. Said inorganic, ion-conducting material preferably comprises particles having a maximum diameter of less than 100 nm. This further development provides the advantage of improving the stability of the secondary cells at temperatures higher than 100° C. Such a separator is sold for example in Germany by Evonik AG under the trade name of “Separion.”

In accordance with a second preferential further development, the separator of one or more of the secondary cells, which does not conduct or only poorly conducts electrons, consists at least largely or completely of a ceramic, preferably an oxide ceramic. This further development provides the advantage of improving the stability of the secondary cells at temperatures higher than 100° C.

In accordance with a third preferential further development, the separator of one or more of the secondary cells is designed according to the teaching of WO 2010/017058. At rising temperature, the separator is partially porous and the ion exchange between neighboring electrodes reduced. This further development provides the advantage of increasing the safety of the secondary battery.

At least one electrode of the secondary cell, particularly preferentially a cathode, preferably comprises a compound of the LiMPO₄ formula, whereby M is at least one transition metal cation from the first row of the periodic table of the elements. The transition metal cation is preferably selected from among the group consisting of Mn, Fe, Ni and Ti or a combination of these elements. The compound preferably exhibits an olivine structure, preferably primary olivine, whereby Fe is particularly preferential.

In a further embodiment, preferably at least one electrode of the secondary cell, particularly preferentially at least one cathode, comprises a lithium manganate, preferably LiMn₂O₄ of spinel type, a lithium cobalate, preferably LiCoO₂, or a lithium nickelate, preferably LiNiO₂, or a mixture of two or three of these oxides, or a lithium-mixed oxide containing manganese, cobalt and nickel.

The secondary battery can preferably be reversibly converted from a first supply state into a second supply state, particularly as a function of at least one of said physical parameters related to one of said, particularly used, secondary cells. Said first supply state is characterized by all of the particularly used secondary cells being electrically connected to two of the battery terminals of different polarity (P+, P−) at least indirectly, particularly via the interconnect device. The second supply state is characterized by at least one of said secondary cells not being electrically connected to the two battery terminals of different polarity. This preferred embodiment provides the advantage of one of said secondary cells being able to be at least intermittently electrically isolated, particularly when a detected physical parameter suggests a conclusion of insufficient function or malfunction of the secondary cell.

Preferably, the particularly periodical converting between the two supply states occurs to compensate the different states of charge of the secondary battery's different secondary cells. The present preferred embodiment provides the advantage of improving utilization of the cell charging capacities.

In accordance with a first preferential further development, different secondary cells are not electrically connected to the battery terminals during two temporally successive second supply states. Thus, electrical energy can only be withdrawn from the secondary cells electrically connected to the battery terminals. This preferred further development provides the advantage of improving utilization of the cell charging capacities.

In accordance with a second preferential further development, the same secondary cell is not electrically connected to the battery terminals during two temporally successive second supply states. Thus, electrical energy can only be withdrawn from the secondary cells electrically connected to the battery terminals. The present preferred further development provides the advantage of being able to adapt the energy content of said secondary cell to the energy content of further of said secondary cells of the same secondary battery.

The secondary battery preferably comprises two or more of said secondary cells. The secondary cells are at least intermittently electrically connected to two of the battery terminals of different polarity (P+, P−) by means of the interconnect device. The functional device or the interconnect device comprises one or more of said switch elements, preferably one switch element per secondary cell. The at least one switch element is designed for the reversible bypassing of one of the secondary cells. The at least one switch element preferably serves as a safeguard and a contactor simultaneously. The at least one switch element is preferably designed as a semiconductor switch. In order to convert from the first to the second supply state, the battery control device actuates one or more of said switch elements.

The present preferential embodiment provides the advantage of preventing further exchange of electrical energy with a defective secondary cell. This preferential embodiment provides the advantage of being able to at least intermittently prevent further exchange of electrical energy with an overloaded secondary cell, particularly at excessive temperature of the secondary cell. This preferential embodiment provides the advantage of being able to include an initially redundant secondary cell into the supply of a load, particularly when a defective or overloaded secondary cell is isolated from at least one of the battery terminals. This preferential embodiment provides the advantage of being able to compensate different states of charge of different secondary cells. This preferential embodiment provides the advantage of being able to better utilize individual secondary cells which have a higher cell charging capacity or a higher state of charge, particularly by means of a higher “duty cycle.”

### PREFERRED EMBODIMENTS OF THE SECONDARY BATTERY

In accordance with a first preferred embodiment, the secondary battery is designed using the first preferred embodiment of the housing assembly. The present preferred embodiment provides the advantage of the functional device of the housing assembly being able to perform multiple functions related to the operation of the secondary battery, or at least one secondary cell respectively, which in the known designs of secondary batteries are performed by separate components. This preferred embodiment provides the advantage of the housing assembly being able to be manufactured independently of the assembly of the secondary battery, particularly with respect to both time and location. This preferred embodiment provides the advantage of improving the cohesion of the functional elements in the wall of the housing assembly with respect to vibrations or impacts during the operation of the secondary battery.

In accordance with a second preferred embodiment, the secondary battery is designed using the second preferred embodiment of the housing assembly. The present preferred embodiment provides the advantage of the functional device of the housing assembly being able to perform multiple functions related to the operation of the secondary battery, or at least one secondary cell respectively, which in the known designs of secondary batteries are performed by separate components. This preferred embodiment provides the advantage of the housing assembly being able to be manufactured independently of the assembly of the secondary battery, particularly with respect to both time and location. This preferred embodiment provides the advantage of improving the cohesion of the functional elements in the wall of the housing assembly with respect to vibrations or impacts during the operation of the secondary battery. This preferred embodiment provides the advantage of improving the safety of a secondary battery furnished with the present embodiment of the housing assembly.

In accordance with a third preferred embodiment of the secondary battery, at least one of the functional devices comprises the battery control device, an acceleration sensor, two of said battery terminals of different polarity, to which the secondary cells are at least intermittently electrically connected, one of said switch elements and the discharge resistor. A current path can run from one of said battery terminals via the switch element and the discharge resistor to the other of said battery terminals when the switch element is closed. The battery control device is designed to close said switch element and thus establish the current path when an acceleration detected by the acceleration sensor exceeds a minimum value upon the acceleration detected by the acceleration sensor indicating the secondary battery suffered an accident. This preferred embodiment provides the advantage of improving the safety of a secondary battery.

In accordance with a fourth preferred embodiment of the secondary battery, the functional device comprises one or more of said fluid passages and the housing assembly at least one of said fluid channels. The at least one fluid channel is connected to one or more of said fluid passages. One or more of said fluid passages can be connected to one, particularly independent, fluid conveyor device for the conveying of the temperature-control fluid or extinguishing agent through the at least one fluid channel. This preferred embodiment provides the advantage of improving the safety of a secondary battery.

### Method for Manufacturing the Housing Assembly

The method according to the invention for manufacturing the housing assembly is characterized by at least one of the following steps:
S1 producing one of the functional devices having at least one of said functional elements, preferably consolidating a plurality of said functional elements particularly on the circuit support, whereupon said functional device is formed,
S2 providing one of said first support elements, particularly from a second stockage, particularly subsequent to step S1,
S3 placing the at least one functional device particularly formed with the circuit support on the first support element or another of said functional devices, particularly from a first stockage, particularly subsequent step S2,
S4 connecting, particularly materially, the first support element to the at least one functional device, whereupon a layered composite is formed, particularly under the influence of heat, particularly at a working temperature which at least corresponds to the softening temperature of the first polymer material of the first support element, particularly by means of isotactic or continuous press, particularly subsequent to step S3,
S5 placing a second support element on one of said functional devices, preferably from a third stockage, particularly subsequent to step S3,
S6 connecting, particularly materially, the second support element to one of said functional devices, particularly to the neighboring functional device, particularly under the influence of heat, particularly at a working temperature which at least corresponds to the softening temperature of the first polymer material of the second support element, particularly by means of isotactic or continuous press, particularly subsequent to step S5,
S7 storing the layered composite in a fourth stockage, particularly subsequent to step S4 or S6,
S8 withdrawing the layered composite particularly from the fourth stockage, particularly subsequent to step S7,
S9 cutting to length at least one substantially planar molded blank from the layered composite, preferably by means of a cutting device, particularly subsequent to step S8,
S10 warming the layered composite, or the substantially planar molded blank respectively, particularly to a working temperature which corresponds at least to the softening temperature of the first polymer material of the first support element, particularly subsequent to step S9,
S11 feeding the substantially planar molded blank into a forming tool, particularly subsequent to step S10,
S13 forming the receiving space in the molded blank for the at least one secondary cell, particularly by means of deforming the in particular warmed molded blank with the forming tool, whereby the forming tool is adapted to the shape of the at least one secondary cell, wherein the receiving space is created, particularly preferentially by closing the forming tool, whereupon the housing assembly is formed, particularly subsequent to step S11,
S15 solidifying the deformed molded blank, the housing assembly respectively, preferably by cooling to a removal temperature which is in particular lower than the softening temperature of the first polymer material, particularly subsequent to step S13,
S16 removing the in particular deformed molded blank, the housing assembly respectively, from the forming tool, particularly at a removal temperature which is lower than the softening temperature of the first polymer material, particularly subsequent to step S15.

The inventive manufacturing method provides the advantage of being able to manufacture the housing assembly with a predefined flexural rigidity and/or a predefined energy consumption ability relative a foreign object impacting the secondary battery from the environment, whereby in particular the mechanical resistance of the secondary battery is improved. To this end, step S2 is preferably performed a plurality of times prior to step S4, whereupon a plurality of first support elements are connected with the at least one functional device into a layered composite or molded blank respectively.

The inventive manufacturing method provides the advantage of being able to manufacture the housing assembly, which has a predefined flexural rigidity and/or a predefined energy consumption ability relative a foreign object impacting the secondary battery from the environment within the operating temperature range, with a lower expenditure of energy at the working temperature.

The inventive manufacturing method provides the advantage of the first support element improving the cohesion of the functional device, whereby the resistance of the secondary battery to vibrations, or the functioning of the converter cell upon vibrations respectively, is improved.

The inventive manufacturing method provides the advantage of simplifying the manufacturing steps subsequent the forming of the functional device, the layered composite and/or the housing assembly, thereby saving on manufacturing costs. The inventive manufacturing method provides the further advantage of improving the production yield and quality.

The inventive manufacturing method provides the advantage of being able to easily and cost-effectively adapt the housing assembly to the secondary cells having different charging capacities and/or dimensions, in particular by the receiving space being able to be produced in the first housing part immediately prior to the inserting of the secondary cells. Doing so can thus lower storage costs.

In accordance with a first preferred embodiment, the manufacturing method comprises steps S1, S4, S10 and S13. This preferred embodiment provides the advantage of simplifying the forming of the receiving space.

In accordance with a second preferred embodiment, the manufacturing method comprises steps S1, S4 and S13, wherein S4 is performed at a working temperature which at least corresponds to the softening temperature of the first polymer material of the first support element, wherein step S13 immediately follows after step S4. This preferred embodiment provides the advantage of being able to dispense with supplying energy for the renewed warming of the layered composite, the molded blank respectively, prior to step S13.

In accordance with a third preferred embodiment, which also comprises the steps of one of the above preferred embodiments, the manufacturing method additionally also comprises step S7. This preferred embodiment provides the advantage of the layered composite being able to be manufactured independently of step S13 with respect to both time and location.

In accordance with a fourth preferred embodiment, which also comprises the steps of one of the above preferred embodiments, the manufacturing method comprises steps S5 and S6 between steps S4 and S16. This preferred embodiment provides the advantage of increasing the wall's predefined flexural rigidity and/or the predefined energy consumption ability relative a foreign object impacting the secondary battery from the environment.

### BRIEF DESCRIPTION OF THE DRAWINGS

Further advantages, features and possible applications of the present invention will follow from the following description in conjunction with the figures, which show:

FIG. 1 FIG. 1a and FIG. 1b each show a schematic view of a preferred embodiment of the housing assembly, also with secondary cells in the receiving space,

FIG. 2 a schematic view of two different layered composites for different housing assembly walls,

FIG. 3 a schematic sectional view through first housing parts having different functional elements, respectively first and second layer sections,

FIG. 4 a schematic view of a wall of the housing assembly,

FIG. 5 a schematic sectional view through the wall of the housing assembly having a metallic insert,

FIG. 6 FIG. 6a and FIG. 6b each show a schematic view of a layered composite having two support elements and a functional device pursuant step S6, also pursuant step S13,

FIG. 7 a schematic view of a processing device for producing a layered composite for one of the housing assemblies,

FIG. 8 a schematic view of a processing device for producing a layered composite for a preferred embodiment of the housing assembly, wherein one of said functional devices is configured with a circuit support,

FIG. 9 a schematic view of cutting molded blanks to length from a prepared layered composite.

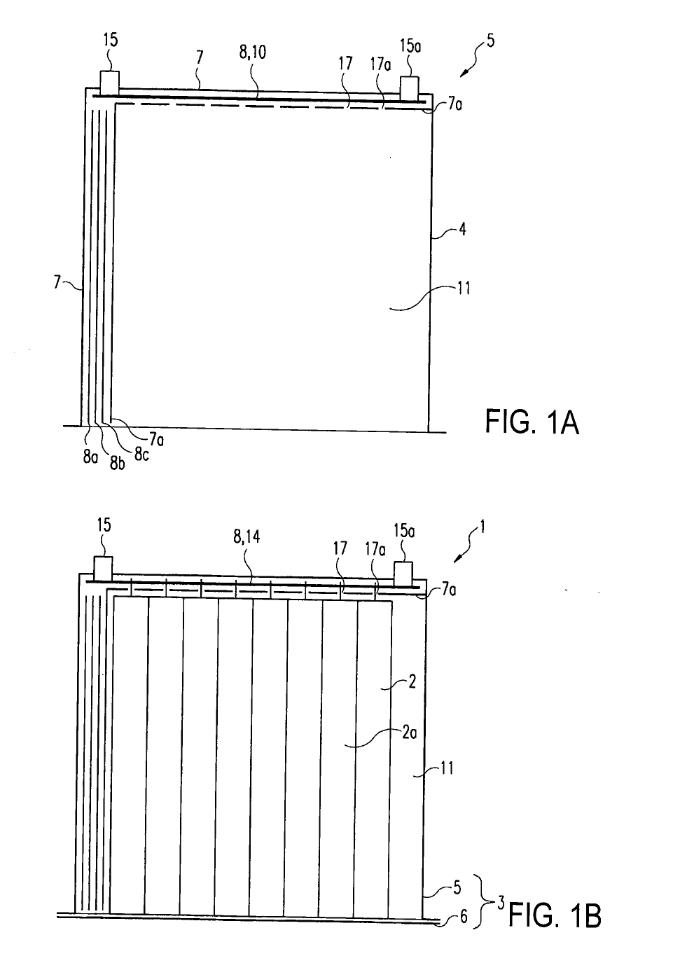

FIG. 1a shows a schematic view of one preferred embodiment of the housing assembly 5, also with secondary cells 2, 2a in the receiving space 11. The housing assembly 5 comprises a wall 4 having two sections. The wall 4 encloses at least sections of the receiving space 11. The wall 4 exhibits a circumferential collar which serves in the connection to a not shown second housing part.

In the first section, the wall 4 comprises a first support element 7, a second support element 7a and a functional device 8. Each support element 7, 7a comprises a first polymer material interspersed with glass fibers. The second support element 7a comprises recesses 17, 17a for the cell terminals of the secondary cells to be received. The functional device 8 comprising a circuit support 10 is arranged between and materially connected to said support elements 7, 7a.

The circuit support 10 accommodates the battery terminals 15, 15a of different polarity as well as further functional elements. Not shown are the battery control device, the interconnect device, the data storage device, a plurality of sensors and the communication device, designed as a short-range wireless device. Nor are a plurality of functional device contact elements shown, wherein the contact elements serve in contacting the cell terminals of the secondary cells to be received.

The functional device 8 is designed such that at least two of the secondary cells to be received are used to supply energy to the functional device 8.

In a second wall section, three functional devices 8, 8a, 8b are disposed between the support elements 7, 7a. Not shown is the electrical connection of the first functional device 8 to battery terminal 15 and the connection of the third functional device 8b to battery terminal 16. Both the first functional device 8 as well as also the third functional device 8b are configured as metal foils. The second functional device 8a is configured as a plastic film and isolates the first functional device 8 from the third functional device 8b. When a foreign object punctures the second functional device 8a, a current path through which the secondary cells to be received can be at least partially charged is closed.

FIG. 1b shows the housing assembly of FIG. 1a, wherein secondary cells 2, 2a have been inserted into the receiving space 11. The cell terminals of the secondary cells 2, 2a are electrically connected to the functional device 8 through recesses 17, 17a of the second support element 7a. The secondary cells 2, 2a can be connected to the battery terminals 15, 15a by means of the not specifically depicted interconnect device 14.

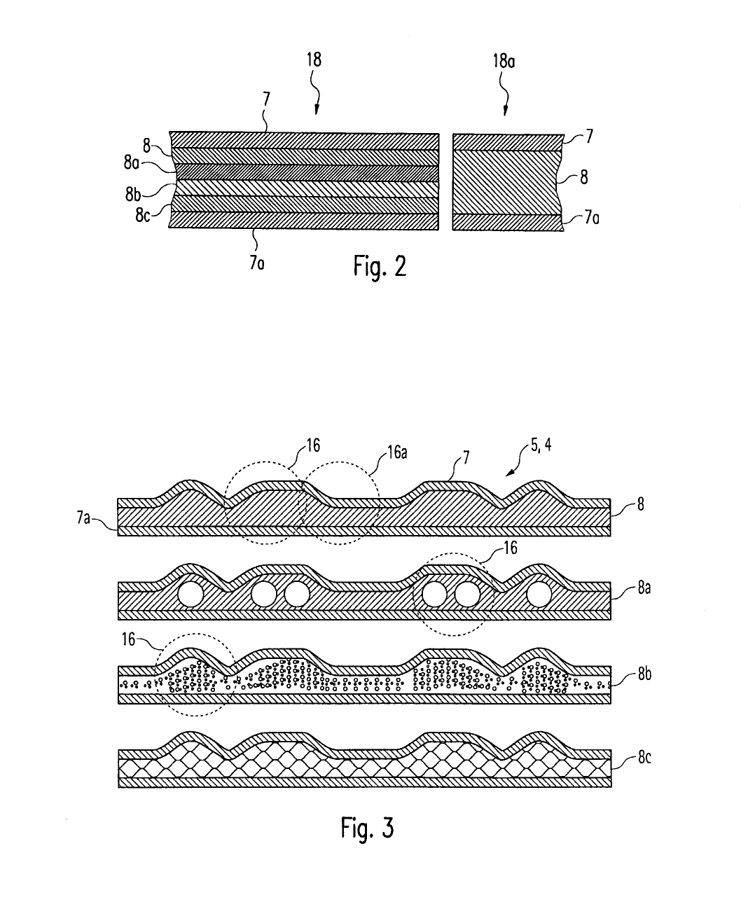

FIG. 2 shows a schematic view of two different layered composites 18, 18a for a housing assembly. The first support element 7 and the second support element 7a are advantageously designed as base layers.

The layered composite 18 comprises two support elements 7, 7a, which surround or enclose four functional devices 8, 8a, 8b, 8c. The individual functional devices 8, 8a, 8b, 8c fulfill different tasks and comprise different functional elements thereto. Not shown is that the fourth functional device 8c comprises a pressure sensor, a thermocouple and battery control device which processes the signals or measured values respectively of the cited sensor and controls the operation of the likewise not shown secondary cell. The functional device 8 is configured as a cotton layer with the first component of a two-component polyurethane sealant. The third functional device 8b is configured as a layer with the second component of the two-component polyurethane sealant. The second functional device 8a distances the first functional device 8 from the third functional device 8b and separates the components from one another. When a foreign object penetrates into the housing assembly and thereby punctures the second functional device 8a, the two components then come into contact in the area of the penetrated foreign object and trigger the formation of the polyurethane sealant. The polyurethane sealant serves to reduce or close the opening through which water could undesirably enter into the receiving space from the environment.

Layered composite 18a only comprises one functional device 8, accommodating the pressure sensor, the thermocouple and the battery control device which are part of the same functional device 8.

FIG. 3 shows a schematic sectional view through different configurations of the housing assembly 5 having different functional devices 8, 8a, 8b, 8c as well as first and second layer sections 16, 16a. The functional device 8 is enclosed by the first support element 7 and the second support element 7a. The first support element 7 and the second support element 7a are advantageously designed as base layers. The functional device 8 has two layer sections 16, 16a, wherein the first layer section 16 exhibits a greater wall thickness than the second layer section 16a. Functional device 8a has a plurality of first layer sections 16 through which fluid channels for a temperature-control fluid run. Functional device 8b has a plurality of first layer sections 16 which are filled with a foam. To that end, the functional device 8a is filled with an expandable filler material which forms cavities upon the input of activation energy. Functional device 8c exhibits a cavity structure, particularly a honeycomb structure, which serves to reduce weight while increasing the flexural rigidity of the housing assembly 5.

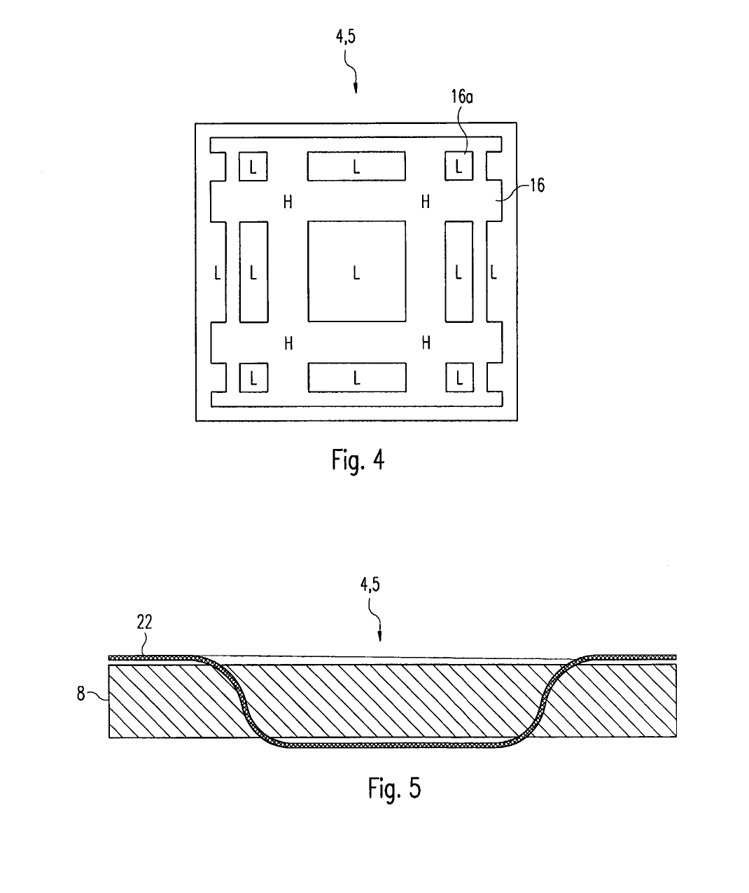

FIG. 4 shows a schematic view of the housing assembly 5 with first layer sections 16 and second layer sections 16a of the same functional device. The first layer sections 16, also marked by the letter “H”, have a larger wall thickness than the second layer sections 16a, also marked by the letter “L”. The first support element 7 and the second support element 7a are advantageously designed as base layers.

FIG. 5 shows a schematic sectional view through the wall 4 of the housing assembly 5 having an in particular metal insert 22 which extends both into the functional device 8 as well as beyond said functional device 8. To simplify the representation, the neighboring support elements are not depicted. The insert 22 serves to reinforce the housing assembly 5, particularly to increase the flexural rigidity of the housing assembly 5. The insert 22 is profiled for increased flexural rigidity.

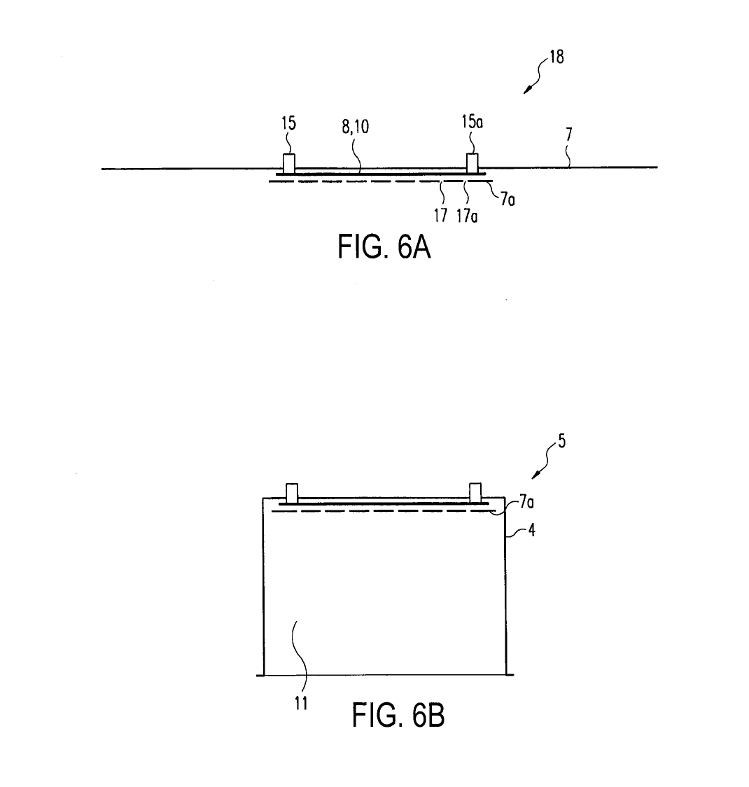

FIG. 6a shows a layered composite 18 for the wall of the housing assembly, particularly pursuant step S5. The layered composite 18 comprises the first support element 7, one of the functional devices 8 and the second support element 7a, wherein the functional device 8 is enclosed by and materially connected to the support elements 7, 7a. Two battery terminals 15, 15a extend through the first support element 7. The second support element 7a comprises recesses 17; 17a for the cell terminals of secondary cells. The support elements 7, 7a are formed with a glass fiber-filled first polymer material, particularly a thermoplastic. The first support element 7 extends over the edges of the functional device 8 as well as the second support element 7a.

The functional device 8 is designed with a circuit support 10. Said circuit support 10 centralizes the not shown battery control device, interconnect device, sensor and preferably the data storage device and/or communication device.

FIG. 6b shows the layered composite of FIG. 6a after step S13. The layered composite is shaped to form the receiving space 11. Said deforming raises sections of the wall 4. These raised sections serve to enclose, support and protect the secondary cells to be received by the receiving space 11. After the receiving space 11 has been formed, the housing assembly 5 is ready to receive secondary cells.

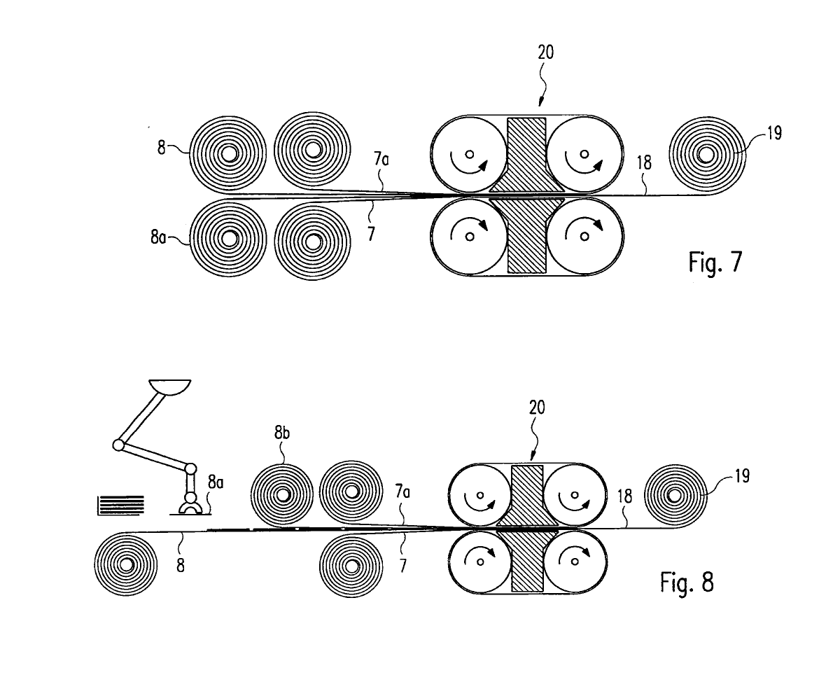

FIG. 7 shows a schematic view of a processing device 20 for producing a layered composite 18 for a housing assembly. The first support element 7, the second support element 7a and two functional devices 8, 8a are uncoiled from different stockages. The first support element 7 and the second support element 7a are advantageously designed as base layers. Said layers are fed to the processing device 20, configured here as a double belt press. The layers stacked one atop the other are joined together in the double belt press 20 into the layered composite 18, particularly when subjected to heat. The layered composite 18 is fed to a stockage 19.

FIG. 8 shows a schematic view of a processing device 20 for producing a layered composite 18 for a preferred embodiment of the housing assembly having a plurality of functional devices 8, 8a, 8c, wherein one of said functional devices 8a is configured with a circuit support. First functional device 8 is uncoiled first. The functional devices 8a are individually disposed on the first functional device 8 by a gripper, preferably with a minimum spacing between two functional devices 8a. A further functional device 8b as well as two support elements 7, 7a are uncoiled. The first support element 7 and the second support element 7a are advantageously designed as base layers. The support elements 7, 7a enclose the functional device 8a before the layer is fed to the double belt press 20. The layered composite 18 is produced within the double belt press 20, particularly under the influence of heat. The layered composite 18 is then fed to stockage 19.

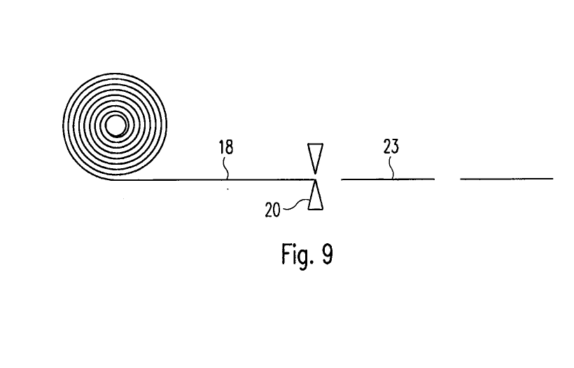

FIG. 9 shows a schematic view of cutting molded blanks 23 to length from a prepared layered composite 18, particularly by means of a cutting device 20. If one of the functional devices is formed with a circuit support, the layered composite 18 is separated and/or cut to length between two such circuit supports.

### LIST OF REFERENCE NUMERALS

1 secondary battery
2, 2a secondary cell
3 battery case
4 wall
5 housing assembly
6 second housing part
7, 7a support element
8, 8a, 8b, 8c functional device
9, 9a functional element
10 circuit support
11 receiving space
12 load
13 battery control device
14 interconnect device
15, 15a battery terminal
16, 16a layer section
17, 17a recess
18, 18a layered composite
19 stockage
20 processing device, forming tool
22 insert
23 molded blank
24, 24a fluid passage

1. A housing assembly for a secondary battery, comprising
a receiving space which is designed to receive at least one secondary cell,
at least one wall which is designed to delimit the receiving space,
wherein the at least one wall comprises:
a functional device which is designed to enable and/or assist the release of energy from the at least one secondary cell, which is designed for the operative connection to the at least one secondary cell,
a first support element which is designed to support the at least one functional device, wherein the first support element is formed from a fiber-interspersed first polymer material.

2. The housing assembly according to claim 1, wherein
the at least one functional device comprises at least one functional element which is connectable to the at least one secondary cell, and
the at least one functional element is designed as a battery terminal, sensor, battery control device, switch element, interconnect device, fluid passage, actuating device, data storage device or communication device.

3. The housing assembly according to claim 1, wherein
the wall comprises an activatable filler material,
the activatable filler material is designed to form cavities upon the introduction of activation energy or triggered by one of said functional elements, or
to seal the wall upon an independent foreign object penetrating the wall.

4. A battery case, comprising:
a housing assembly according to claim 1, and
a second housing part,
wherein
the housing assembly can be detachably connected to the second housing part,
the housing assembly comprises a closeable opening through which the at least one secondary cell can be inserted into the receiving space,
the opening can be closed by the second housing part.

5. A secondary battery having one of the housing assemblies in accordance with claim 1, comprising:
at least two secondary cells, each having a cell voltage, which are designed to at least intermittently supply electrical energy,
wherein the at least one functional device comprises:
two of the battery terminals having different polarity (P+, P−), to which the cell voltage of the secondary cells at least intermittently contact,
the interconnect device, which is designed to interconnect the at least two secondary cells, which is designed to at least intermittently separably connect the at least two secondary cells electrically to the battery terminals of different polarity (P+, P−),
the battery control device, which is designed to control and/or monitor the interconnect device, which is designed to control and/or monitor the charging and/or discharging of the at least two secondary cells.

6. The secondary battery in accordance with claim 5, wherein
a first supply state in which all of the secondary cells are connected to the battery terminals of different polarity (P+, P−) at least indirectly via the interconnect device,
a second supply state in which at least one of the secondary cells is not electrically connected to the battery terminals of different polarity (P+, P−),
wherein the secondary battery can be reversibly converted from the first supply state into the second supply state.

7. A method for manufacturing the housing assembly according to claim 1, comprising at least one of S1 to S16:
S1 producing one of the functional devices having at least one of said functional elements, or consolidating a plurality of said functional elements, on the circuit support, whereupon said functional device is formed,
S2 providing one of said first support elements,
S3 placing the at least one functional device on the first support element or another of said functional devices,
S4 connecting the first support element to the at least one functional device, whereupon a layered composite is formed,
S5 placing a second support element on one of said functional devices,
S6 connecting, materially, the second support element to one of said functional devices,
S7 storing the layered composite in a fourth stockage,
S8 withdrawing the layered composite from the fourth stockage,
S9 cutting to length at least one substantially planar molded blank from the layered composite
S10 warming the substantially planar molded blank
S11 feeding the substantially planar molded blank into a forming tool
S13 forming the receiving space in the molded blank for the at least one secondary cell, wherein the forming tool is adapted to the shape of the at least one secondary cell, wherein the receiving space is created, whereupon the housing assembly is formed,
S15 solidifying the deformed molded blank, the housing assembly respectively,
S16 removing the deformed molded blank, the housing assembly respectively, from the forming tool.

8. The method according to claim 7, comprising: S1, S4, S10 and S13.

9. The housing assembly according to claim 2, wherein the at least one functional device comprises
two of the battery terminals of different polarity (P+, P−),
the battery control device, and
the interconnect device, or
comprises a circuit support, which is designed to support said at least one functional element, or to electrically interconnect at least two of said functional elements.

10. The secondary battery in accordance with claim 5, comprising at least one of the sensors which is designed to detect at least one of the physical parameters related to one of the secondary cells, wherein the at least one physical parameter allows a conclusion to be drawn as to the functioning of the secondary cell.
